(19) United States
(12) Patent Application Publication
(10) Pub. No.: US 2012/0162205 A1
(43) Pub. Date: Jun. 28, 2012

(54) INFORMATION PROCESSING APPARATUS AND INFORMATION PROCESSING METHOD

(75) Inventors: Junko SAKURAI, Musashino-shi (JP); Teruo KINOSHITA, Nishitama-gun (JP); Hiroshi MIYAUCHI, Yokohama-shi (JP)

(73) Assignee: KABUSHIKI KAISHA TOSHIBA, Tokyo (JP)

(21) Appl. No.: 13/306,722

(22) Filed: Nov. 29, 2011

(30) Foreign Application Priority Data
Dec. 24, 2010 (JP) 2010-288821

(51) Int. Cl. G06T 15/00

(52) U.S. Cl. 345/419

(57) ABSTRACT

According to one embodiment, an information processing apparatus comprises a first display and a second display. The first display is configured to display a first content in one of a two-dimensional mode and three-dimensional mode. The second display is configured to display a second content in one of the two-dimensional mode and three-dimensional mode.

### CROSS-REFERENCE TO RELATED APPLICATIONS

This application is based upon and claims the benefit of priority from prior Japanese Patent Application No. 2010-288821, filed Dec. 24, 2010, the entire contents of which are incorporated herein by reference.

### FIELD

Embodiments described herein relate generally to an information processing apparatus and information processing method that process image information.

### BACKGROUND

Recently, various techniques for displaying three-dimensional images on image display devices such as television receivers are put into practice. A device that can display a three-dimensional image in an information processing apparatus such as a personal computer has also been developed. In such an image display device, for example, the user senses a three-dimensional image (stereoscopic image) by using left-eye and right-eye images based on binocular parallax. Since the information processing apparatus executes various applications, there may occur a case wherein three-dimensional display cannot be made, depending on the application or content to be displayed or two-dimensional display may be more suitably made. Further, in a small portable information processing apparatus, it may become difficult to view a three-dimensional image, depending on the direction thereof at the operation time. Therefore, it is sometimes inappropriate to design the information processing apparatus to always provide three-dimensional display in the information processing apparatus.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the external appearance of an information processing apparatus according to one embodiment.

FIG. 2 is an exemplary block diagram showing the system configuration of an information processing unit of the embodiment.

FIG. 3 is an exemplary block diagram showing the software configuration of an image reproduction application of FIG. 2.

FIG. 4A and FIG. 4B are exemplary views showing one example of a display mode of the embodiment.

FIG. 5A and FIG. 5B are exemplary views showing another example of a display mode of the embodiment.

FIG. 6 is an exemplary perspective view showing the external appearance of an information processing apparatus according to another embodiment.

### DETAILED DESCRIPTION

Various embodiments will be described hereinafter with reference to the accompanying drawings.

In general, according to one embodiment, an information processing apparatus comprises a first display and a second display. The first display is configured to display a first content in one of a two-dimensional mode and three-dimensional mode. The second display is configured to display a second content in one of the two-dimensional mode and three-dimensional mode.

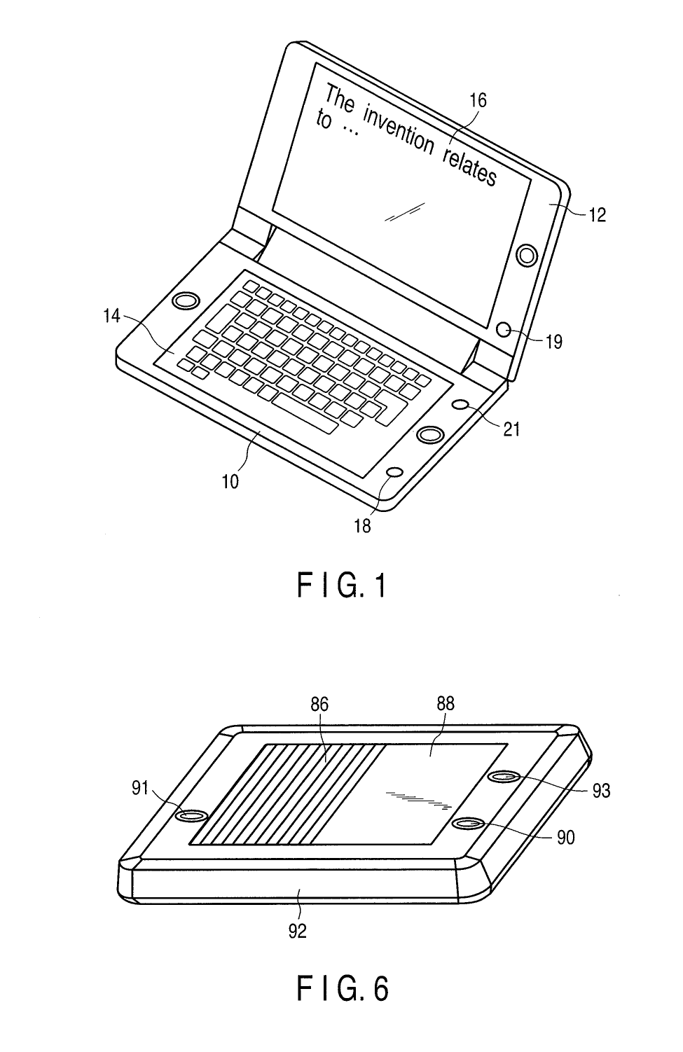

FIG. 1 is a view showing the external appearance of an information processing apparatus according to one embodiment. For example, the information processing apparatus has the external appearance of a notebook personal computer but has no hardware keyboard, unlike a normal personal computer. The information processing apparatus includes a first unit 10 and second unit 12 respectively including a first display 14 and second display 16 that are each configured by an LCD (liquid crystal display) panel. Each of the first display 14 and second display 16 has a touch panel function. The first display 14 and second display 16 can be used as software keyboards by displaying keyboard images on the first display 14 and second display 16.

The first display 14 and second display 16 have lenticular lenses for three-dimensional display disposed on the front surfaces of the LDC panels thereof. The lenticular lens may degrade the resolution at the time of two-dimensional display and make the contour of characters or the like jagged. In order to prevent this, it has been considered to provide electrodes on the lenticular lens and prevent occurrence of a lens effect by applying a preset voltage across the electrodes. However, if the resolution of the display is sufficiently high and causes no problem for two-dimensional display, a normal lenticular lens may be used.

The second unit 12 is mounted on the first unit 10 to freely rotate between an open position in which the upper surface of the first unit 10 is exposed and a closed position in which the upper surface of the first unit 10 is covered therewith. For example, if the information processing apparatus is used as a notebook personal computer, the first display 14 of the first unit 10 is used as a software keyboard and characters and images are displayed only on the second display 16 of the second unit 12. Alternatively, if the information processing apparatus is used as an electronic book reader, characters and images are displayed on both of the first display 14 and second display 16. A power source button 21 is provided on the casing of the first unit 10. On the casings of the first unit 10 and second unit 12, two-dimensional/three-dimensional switching buttons 18 and 19 are provided.

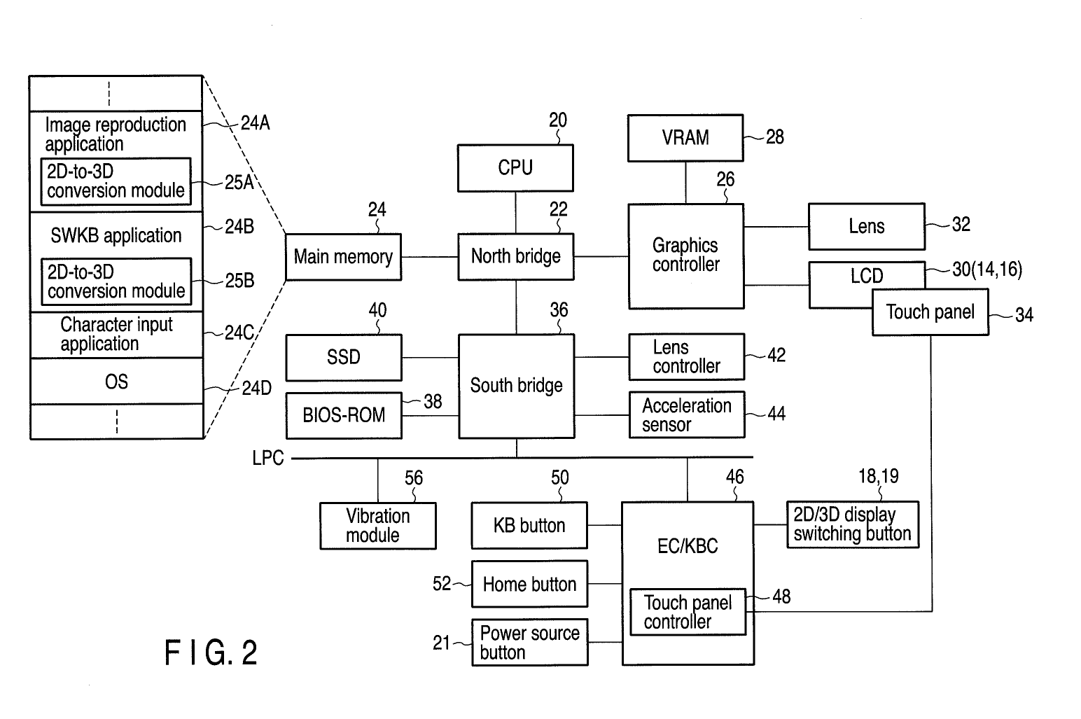

The processor that is a main unit of the information processing apparatus may be provided on each of the first unit 10 and second unit 12 or provided on only one of the units. As one example, the processor provided on each of the first unit 10 and second unit 12 is shown in FIG. 2.

The processor includes a CPU 20, north bridge 22, main memory 24, graphics controller 26, video memory (VRAM) 28, LCD 30 (display 14, 16 in FIG. 1), lenticular lens 32 with electrodes, south bridge 36, BIOS-ROM 38, solid-state drive (SSD) 40, lens controller 42, acceleration sensor 44, embedded controller/keyboard controller (EC/KBC) 46 (including a touch panel controller 48), keyboard (KB) button 50, home button 52, power source button 21 (in the case of the processor of the first unit 10), two-dimensional/three-dimensional switching buttons 18, 19, vibrator 56 and the like. The LCD 30 also includes a touch panel 34.

The SSD 40 is a storage device used instead of a hard disk device and the CPU 20 executes an operating system (OS) and application programs loaded from the SSD 40 to the main memory 24. The application programs include image reproduction application 24A, software keyboard application 24B, character input application 24C and the like. The image reproduction application 24A and software keyboard application 24B respectively include 2D-3D conversion modules 25A and 25B that convert two-dimensional image data to three-dimensional image data.

The image reproduction application 24A is software having a function of causing image content data to be viewed. The image reproduction application 24A performs a live reproduction process for viewing broadcasting program data received by a TV tuner (not shown), a recording process for recording received broadcasting program data in the SSD 40, a reproduction process for reproducing broadcasting program data/video data recorded in the SSD 40, a reproduction process for reproducing image content data received via a network and the like.

The 2D-3D conversion modules 25A and 25B each convert a two-dimensional image contained in image content data to a three-dimensional image on a real-time basis to permit the user to view a three-dimensional image.

The CPU 20 also executes a BIOS (Basic Input/Output System) stored in the BIOS-ROM 38. The BIOS is a program for hardware control.

The north bridge 22 is a bridge device that connects a local bus of the CPU 20 to the south bridge 36. The north bridge 22 also contains a memory controller that controls access to the main memory 24. Further, the north bridge 22 has a function of communicating with the graphics controller 26.

The graphics controller 26 controls the first and second displays (LCD 30). A display signal created by the graphics controller 26 is supplied to the LCD 30 that in turn displays an image based on the display signal. Further, the graphics controller 26 is connected to the lenticular lens 32.

The south bridge 36 controls the respective devices on a PCI (Peripheral Component Interconnect) bus and LPC (Low Pin Count) bus. In the south bridge 36, an IDE (Integrated Drive Electronics) controller used for controlling the SSD 40 and a memory controller used for controlling access to the BIOS-ROM 38 are contained. Further, the south bridge 36 has a function of communicating with the lens controller 42 and acceleration sensor 44. The lens controller 42 applies a preset voltage across the electrodes of the lenticular lens 32 and controls the lens 32 to prevent occurrence of a lens effect at the time of two-dimensional display.

The acceleration sensor 44 senses the positions (horizontal state or vertical state) of the first unit 10 and second unit 12. Since it is difficult to view a three-dimensional image if the display panel is set in the horizontal state, displays on the first display 14 and second display 16 may be switched between the two-dimensional display and three-dimensional display according to the positions of the first unit 10 and second unit 12.

The embedded controller/keyboard controller 46 is a one-chip microcomputer in which an embedded controller for power management and a keyboard controller used for controlling the keyboard button 50 on the software keyboard are integrated. The embedded controller/keyboard controller 46 also includes a touch panel controller 48 used for controlling the touch panel 34. The home button 52 and power source button 21 are also connected to the embedded controller/keyboard controller 46.

The vibrator 56 is provided to attain a haptic feedback function that can be set as an option of a software keyboard function. If the function is activated, the vibrator 56 vibrates when any one of the keys of the software keyboard is touched. As a result, the first unit 10 and second unit 12 vibrate at the key operation time and the operation feeling of the software keyboard increases. Therefore, the vibrator 56 may be provided on one of the first and second units 10, 12.

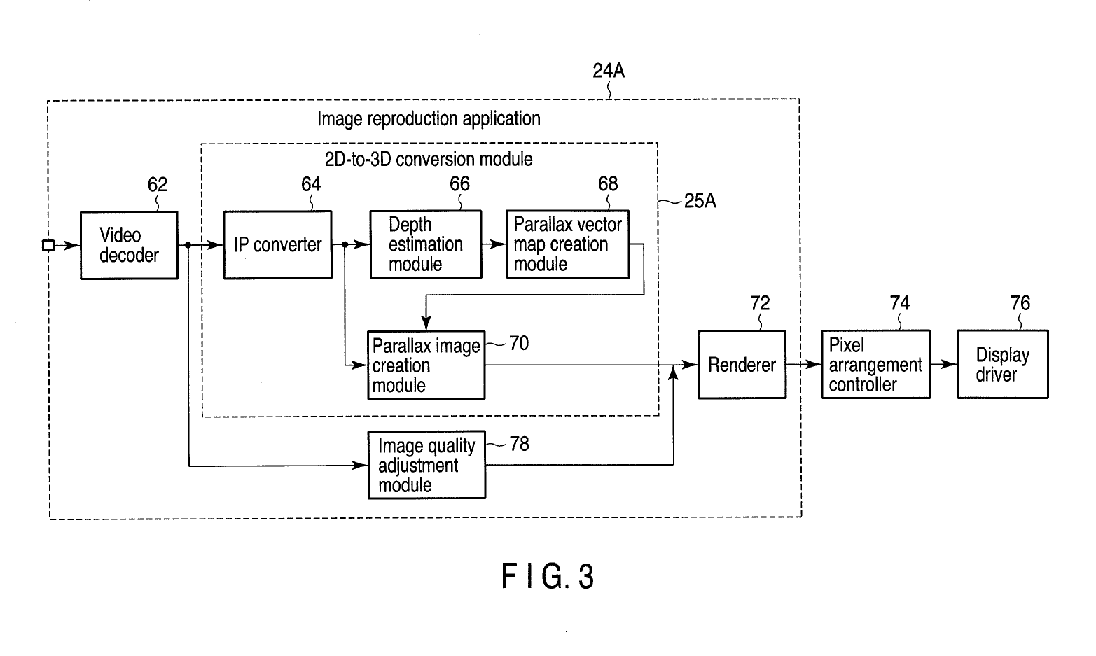

FIG. 3 is a block diagram showing the software configuration of the image reproduction application 24A. A video decoder 62 performs a decoding process with respect to input two-dimensional image data.

In the case of two-dimensional display, image data output from the video decoder 62 is supplied to a renderer 72 via an image quality adjustment module 78 without passing through the 2D-3D conversion module 25A. In the case of three-dimensional display, image data output from the video decoder 62 is supplied to the renderer 72 via the 2D-3D conversion module 25A without passing through the image quality adjustment module 78.

In the 2D-3D conversion module 25A, an IP converter 64 subjects image data after decoding to IP (interlace/progressive) conversion and creates image data in which a deviation that may be the cause of parallax image creation is corrected. A depth estimation module 66 utilizes corrected image data after IP conversion output from the IP converter 64 and analyzes image frames of the image data to estimate the depth position of each pixel contained in each image frame. For example, the depth estimation module 66 estimates the depth position of each pixel based on the movement between the image frames and differences between the pixel values in the image frame. A parallax vector map creation module 68 creates a parallax vector map corresponding to binocular parallax with respect to an estimated depth position of each pixel based on the depth position.

A parallax image creation module 70 creates a plurality of parallax images having parallax to display a three-dimensional image in the depth position by utilizing corrected image data after IP conversion output from the IP converter 64 and a parallax vector map output from the parallax vector map creation module 68. The parallax image creation module 70 creates two parallax images of left-eye and right-eye images in the case of three-dimensional display using glasses and creates parallax images of a number corresponding to a parallax number in the case of glass-less type three-dimensional display. An output of the parallax image creation module 70 is supplied to the renderer 72.

The image quality adjustment module 78 performs an image quality adjustment process. An output of the image quality adjustment module 78 is also supplied to the renderer 72.

The renderer 72 performs a drawing process for the output of the parallax image creation module 70 or the output of the image quality adjustment module 78. A pixel arrangement controller 74 converts a parallax image subjected to the drawing process to the pixel arrangement for two-dimensional display or three-dimensional display. A display driver 76 performs a two-dimensional display process or three-dimensional display process based on the output of the pixel arrangement controller 74.

Next, the operation of switching the two-dimensional display process/three-dimensional display process of the first unit 10 and second unit 12 is explained.

First, since the two-dimensional/three-dimensional switching buttons 18 and 19 are respectively provided on the casings of the first unit 10 and second unit 12, the user can freely switch display of the first display 14 and second display 16 to the two-dimensional display/three-dimensional display and enjoy images according to his preference. An operation member used by the user to specify the two-dimensional display/three-dimensional display is not limited to the exclusive buttons 18, 19 and a key used for serving the above purpose may be provided on the software keyboard as will be described later or the purpose can be attained by a combination of preset key operations.

Next, an example of automatically switching the two-dimensional display/three-dimensional display without setting by the user's operation is explained.

The two-dimensional display/three-dimensional display can be switched based on the type of applications executed by the processors of the first unit 10 and second unit 12. For example, the two-dimensional display may be selected while an application (for example, character input application 24C) related to character edition is being executed and the three-dimensional display may be selected while an application (for example, image reproduction application 24A) related to an image is being executed. Alternatively, the two-dimensional display/three-dimensional display can be switched based on the type of contents displayed by the processors of the first unit 10 and second unit 12. For example, the two-dimensional display may be selected when a still image is displayed and the three-dimensional display may be selected when a moving image is displayed. As a result, the user can automatically view an optimum image according to the type of the contents or application of an active window without setting by the user's operation.

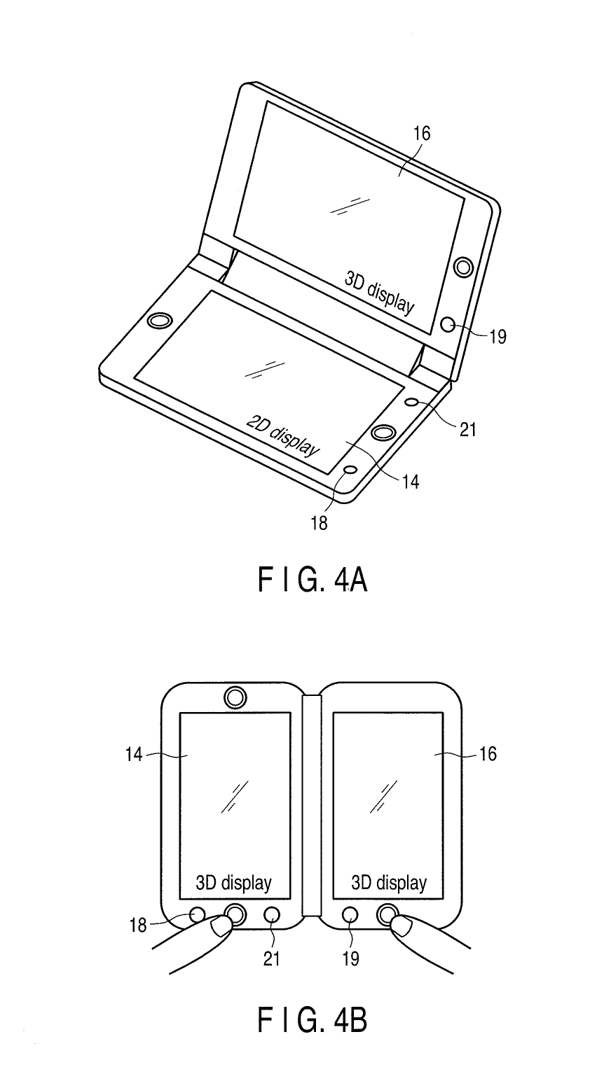

In the two-screen information processing apparatus shown in FIG. 1, various application configurations can be assumed. When the apparatus is used in a horizontally oriented position on a desk as shown in FIG. 4A like a normal notebook PC, the lower-side display 14 is set in a horizontal state and it becomes difficult to view a three-dimensional image. At this time, since the user mainly views the upper-side display 16, the lower-side display 14 may be set to provide two-dimensional display if the acceleration sensor 44 of the lower-side unit 10 detects the horizontal state. Since the upper-side display 16 is set in substantially a vertical state, it is easy to view a three-dimensional image and the user mainly views the upper-side display 16, the upper-side display 16 may be set to provide three-dimensional display if the acceleration sensor 44 of the upper-side unit 12 does not detect the horizontal state.

If the apparatus is held with both hands and used in a longitudinally oriented position as shown in FIG. 4B, as both of the displays 14 and 16 can be set to provide three-dimensional display since both of the displays 14 and 16 are set in substantially a vertical state, it is easy to view a three-dimensional image and the user views both of the screens.

Thus, it becomes possible to view an image in an optimum display form to meet the application configuration without the user's setting operation by switching the two-dimensional display/three-dimensional display according to the horizontal/vertical state detected by the acceleration sensor 44.

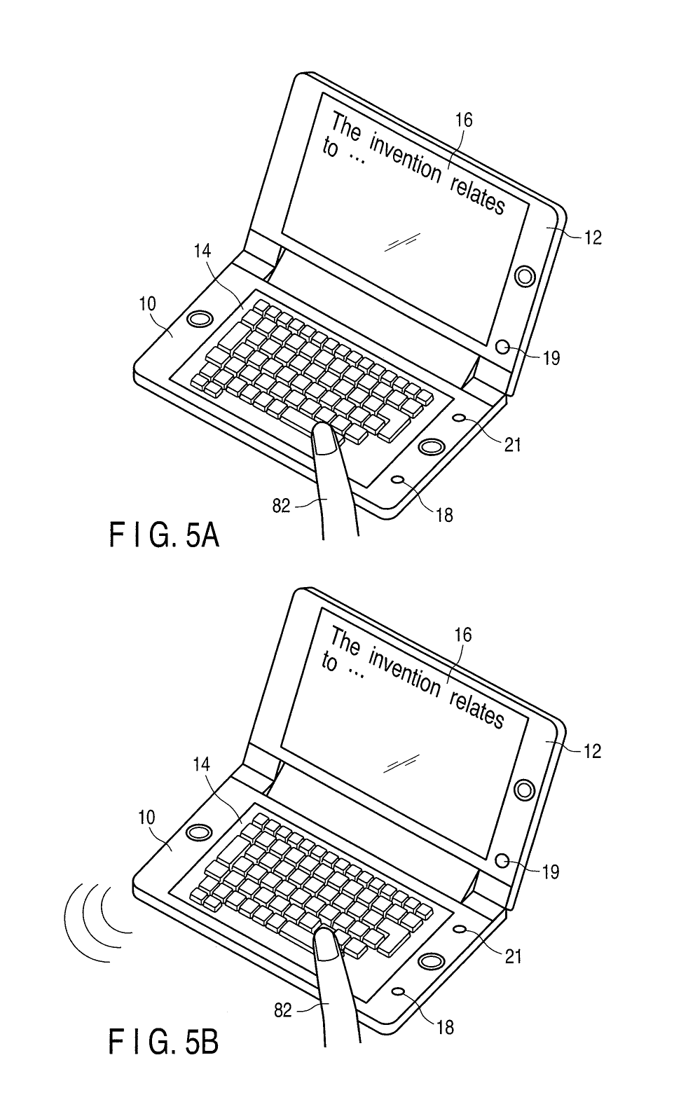

Further, since a hardware keyboard is not provided in the two-screen information processing apparatus, a software keyboard application 24B is provided to display a keyboard on the screen for key input. The software keyboard application 24B can also be displayed in a three-dimensional form. Since the image of the software keyboard is predetermined and a parallax image can be previously created, the 2D-3D conversion module 25B shown in FIG. 3 can be omitted. An example of displaying the software keyboard in a three-dimensional form is shown in FIG. 5A. In FIG. 4A, the lower-side display 14 is set in a two-dimensional display mode, but since a parallax image of the software keyboard that can be stereoscopically viewed can be created, the display 14 that displays the software keyboard sets the three-dimensional display irrespective of the detection state of the acceleration sensor 44.

If the software keyboard is displayed in a three-dimensional form and when the operation of touching a certain key is detected by the touch panel controller 48 as shown in FIG. 5B, the key input is displayed to be easily recognized by switching the key display image to an image of the key set in a pressed state and a more real operation feeling of the software keyboard can be attained.

In the software keyboard application, a haptic feedback function can be set as an option. If the function is activated and when any one of the keys of the software keyboard is touched, the vibrator 56 vibrates. As a result, the first unit 10 and second unit 12 vibrate at the key operation time and a further real operation feeling of the software keyboard can be attained. Therefore, if the haptic feedback function and three-dimensional display function are linked and the haptic feedback function of the software keyboard application is activated, the software keyboard may automatically be displayed in a three-dimensional form.

Some references for automatically setting the two-dimensional display and three-dimensional display are explained, but the setting is not limited to the setting based on only one of the references and the two-dimensional display and three-dimensional display can be automatically set based on a combination of the plural references.

The above explanation relates to the two-screen information processing apparatus in which the first and second displays are configured by separate LCD panels provided on the first and second units. However, as shown in FIG. 6, for example, one display panel of a one-screen information processing apparatus can be divided into first and second displays according to regions. FIG. 6 shows the external appearance of an information processing apparatus 92 with a display configured by one LCD panel. Like the example of FIG. 1, the display has a touch panel function and a lenticular lens with electrodes is provided on the LCD panel. The display includes two regions 86, 88 that correspond to the displays 14, 16 of FIG. 1. The regions are not always equally divided and the sizes thereof can be freely set according to the application. A power source switch 93 and two-dimensional/three-dimensional switching buttons 90, 91 are provided on the casing of the information processing apparatus 92. The two-dimensional/three-dimensional switching buttons 90, 91 are operation members by which the user sets display of the display regions 86, 88. The processor shown in FIG. 2 is provided for each of the regions 86, 88 in the casing of the information processing apparatus 92. However, the acceleration sensor 44 and vibrator 56 are provided in only one of the processors of the regions 86 and 88.

The operation of the information processing apparatus 92 of FIG. 6 is the same as that of the two-screen information processing apparatus explained with reference to FIG. 1 to FIG. 5. Therefore, the explanation thereof is omitted. Also, in the example of FIG. 6, the two-dimensional display/three-dimensional display can be switched by the operation of the user to specify the two-dimensional/three-dimensional switching buttons 90, 91 and the user can view an image according to the user's preference. Further, the two-dimensional display/three-dimensional display can automatically be switched according to the type of contents or application of an active window, according to the position of the display panel or according to setting of the haptic feedback function of the software keyboard without setting by the user's operation.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. For example, the number of displays is not limited to two and may be set to three or more. Further, an example in which one application and processor are provided in correspondence to one display is explained, but display according to the same application can be partially switched to two-dimensional display/three-dimensional display. The processor shown in FIG. 2 is explained to be provided for each display, but the CPU 20, main memory 24, SSD 40, BIOS-ROM 38 and the like may be commonly used. In the embodiment of FIG. 1, a modification in which one display panel is divided into first and second displays according to regions like the example of FIG. 6 can be made. Further, a concrete example of three-dimensional display is not limited to a parallax image display system and any type of stereoscopic image display system can be applied thereto.

The procedure of the image reproduction process of this embodiment can be performed by software. Therefore, the same effect as that of the present embodiment can be easily attained simply by installing a program that performs the procedure of the image reproduction process in a general-purpose computer via a non-transitory computer-readable storage medium having the program stored therein and executing the program.

What is claimed is:

1. An information processing apparatus comprising:
a first display configured to display a first content in either a two-dimensional mode or a three-dimensional mode, and
a second display configured to display a second content in either the two-dimensional mode or the three-dimensional mode.

2. The apparatus of claim 1, further comprising:
a first processor configured to process the first content in either the two-dimensional mode or the three-dimensional mode based on an application associated with the first display; and
a second processor configured to process the second content in either the two-dimensional mode or the three-dimensional mode based on an application associated with the second display.

3. The apparatus of claim 1, further comprising:
a first operator configured to set the first display to either the two-dimensional mode or the three-dimensional mode;
a second operator configured to set the second display to either the two-dimensional mode or the three-dimensional mode;
a first processor configured to process the first content in either the two-dimensional mode or the three-dimensional mode based on an operation of the first operator; and
a second processor configured to process the second content in either the two-dimensional mode or the three-dimensional mode based on an operation of the second operator.

4. The apparatus of claim 1, further comprising:
a first unit comprising the first display; and
a second unit comprising the second display,
wherein the first unit and the second unit are configured to move into an open position and a closed position.

5. The apparatus of claim 4, further comprising:
a first detector configured to detect a position of the first unit;
a second detector configured to detect a position of the second unit;
a first processor configured to process the first content in either the two-dimensional mode or the three-dimensional mode based on the position detected by the first detector; and
a second processor configured to process the second content in either the two-dimensional mode or the three-dimensional mode based on the position detected by the second detector.

6. The apparatus of claim 5, wherein
the first processor is configured to process the first content in the two-dimensional mode in response to the position detected by the first detector being a horizontal position and in the three-dimensional mode in response to the position detected by the first detector being a vertical position; and
the second processor is configured to process the second content in the two-dimensional mode in response to the position detected by the second detector being a horizontal position and in the three-dimensional mode in response to the position detected by the second detector being a vertical position.

7. The apparatus of claim 1, further comprising a unit comprising the first display and the second display.

8. The apparatus of claim 7, further comprising:
a detector configured to detect a position of the unit; and
a processor configured to process the first content and the second content in either the two-dimensional mode or the three-dimensional mode based on the position detected by the detector.

9. The apparatus of claim 8, wherein the processor is configured to process the first content and the second content in the two-dimensional mode in response to the position detected by the detector being a horizontal position and in the three-dimensional mode in response to the position detected by the detector being a vertical position.

10. The apparatus of claim 1, further comprising:
a display controller configured to display a three-dimensional keyboard image with a touched key displayed in a pressed state on either the first display or the second display.

11. The apparatus of claim 1, further comprising:
a display controller configured to display a keyboard image on either the first display or the second display; and
a vibrator configured to vibrate upon touching of a key on the keyboard image if a vibration function is activated,
wherein the display controller displays the keyboard image in the three-dimensional mode while the vibration function is activated.

12. The apparatus of claim 11, wherein the display controller displays a touched key in a pressed state.

13. An information processing method of an information processing apparatus comprising a first display configured to display a first content in either a two-dimensional mode or a three-dimensional mode, and a second display configured to display a second content in either the two-dimensional mode or the three-dimensional mode, the method comprising:
setting the first display and the second display to either the two-dimensional mode or the three-dimensional mode according to a user setting comprising applications in association with the first display and the second display and positions of the first display and the second display.

14. The method of claim 13, wherein the two-dimensional mode is set when the first display or the second display is horizontal and the three-dimensional mode is set when the first display or the second display is vertical.

15. The method of claim 13, further comprising:
displaying a three-dimensional keyboard image with a touched key displayed in a pressed state on either the first display or the second display.

16. The method of claim 13, wherein the information processing apparatus further comprises a display controller configured to display a keyboard image on either the first display or the second display, and a vibrator configured to vibrate upon touching of a key on the keyboard image, the method further comprising:
selectively activating or deactivating a vibration function of the vibrator; and
displaying the keyboard image in the three-dimensional mode while the vibration function of the vibrator is activated.
